(19) United States
(12) Patent Application Publication
(10) Pub. No.: US 2021/0254581 A1
(43) Pub. Date: Aug. 19, 2021

(54) COMBINED HEATING AND POWER MODULES AND DEVICES

(71) Applicant: Modern Electron, LLC, Bothell, WA (US)

(72) Inventors: Justin B. Ashton, Palo Alto, CA (US); Stephen E. Clark, Issaquah, WA (US); William Kokonaski, Edmonds, WA (US); Daniel Kraemer, Kirkland, WA (US); John J. Lorr, Redmond, WA (US); Max N. Mankin, Seattle, WA (US); David J. Menacher, Evanston, IL (US); Patrick D. Noble, Seattle, WA (US); Tony S. Pan, Bellevue, WA (US); Alexander J. Pearse, Seattle, WA (US); Ad de Pijper, Redmond, WA (US); Lowell L. Wood, Bellevue, WA (US)

(21) Appl. No.: 17/200,154

(22) Filed: Mar. 12, 2021

Related U.S. Application Data
(63) Continuation-in-part of application No. 16/794,142, filed on Feb. 18, 2020.

(51) Int. Cl. F02G 5/02; F23D 14/32; H01M 6/36

(52) U.S. Cl. CPC F02G 5/02; F23D 14/32; F02G 2254/15; F02G 2254/10; H01M 6/36

(57) ABSTRACT

Various disclosed embodiments include combined heating and power modules and combined heat and power devices. In an illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one alkali metal thermal-to-electricity converter (AMTEC) has a high pressure zone and a low pressure zone, the high pressure zone being thermally couplable to the at least one burner, the low pressure zone being thermally couplable to the heat exchanger.

### RELATED APPLICATION

This application is a continuation-in-part of U.S. patent application Ser. No. 16/794,142 filed Feb. 18, 2020 and entitled “COMBINED HEATING AND POWER MODULES AND DEVICES,” the entire contents of which are hereby incorporated by this reference.

### TECHNICAL FIELD

The present disclosure relates to combined heat and power systems.

### BACKGROUND

The statements in this section merely provide background information related to the present disclosure and may not constitute prior art.

Combined heat and power (“CHP”)—also known as co-generation—refers to the generation of heat and electrical power in the same device or location. In CHP, excess heat from local electrical power generation is delivered to the end-user, thereby resulting in higher combined efficiency than separate electrical power and heat generation. Because of the improvement in overall efficiency, CHP can offer energy cost savings and decreased carbon emissions.

Micro-CHP involves devices producing less than approximately 50 kW of electricity. Micro-CHP has not been widely adopted at power levels of less than approximately 5 kW electricity, despite the vast majority of households in North America and Europe having average demand of 1 kW of electricity or less. This limitation in adoption of micro-CHP is based on a combination of technology and economics. For example, no currently known technology offers a suitable combination of the following characteristics at scales below approximately 5 kW: low capital cost; low or no noise (that is, silent operation); no maintenance for long periods of time; ability to ramp on/off quickly to follow heat usage loads; competitive efficiencies at small scales; and integrability with home heating appliances such as furnaces (for heating air), boilers/water heaters (for heating water), and/or absorption chillers (for providing cooling) (known as “heating units” or “home heating appliances” or the like).

CHP works in two modes. One mode is heat-following mode, in which generating heat is the primary function of the system and electricity is produced whenever heat is in demand by diverting some of the heat into the production of electricity. The other mode is electricity-following, in which the principle function of the system is to produce electricity and the heat produced in the process of generating the electricity is captured for another useful purpose, such as heating water or providing heat for a secondary process.

The higher the utilization rate (that is, on-time) of the electricity generator, the better the economic payback for a micro-CHP unit in heat-following mode. It is desirable to balance the heat load and the demand for electricity. In a CHP device, it is also desirable to transfer waste heat efficiently from the heat engine to air or water. Efficient heat transfer can entail high-quality heat exchangers as well as good thermal/mechanical coupling between the heat engine and the heat exchangers.

### SUMMARY

Various disclosed embodiments include combined heating and power modules and combined heat and power devices.

In an illustrative embodiment, a combined heat and power module includes at least one burner. At least one alkali metal thermal-to-electricity converter (AMTEC) is attached to the at least one burner, the at least one AMTEC having a high pressure zone and a low pressure zone, the high pressure zone being configured to be thermally couplable to the at least one burner, the low pressure zone being configured to be thermally couplable to a heat exchanger.

In another illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one alkali metal thermal-to-electricity converter (AMTEC) has a high pressure zone and a low pressure zone, the high pressure zone being thermally couplable to the at least one burner, the low pressure zone being thermally couplable to the heat exchanger.

In another illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one alkali metal thermal-to-electricity converter (AMTEC) has a high pressure zone and a low pressure zone, the high pressure zone being thermally couplable to the at least one burner, the low pressure zone being thermally couplable to the heat exchanger. An electrical battery is electrically connectable to the at least one igniter and the prime mover.

In another illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one alkali metal thermal-to-electricity converter (AMTEC) has a high pressure zone and a low pressure zone, the high pressure zone being thermally couplable to the at least one burner, the low pressure zone being thermally couplable to the heat exchanger. The AMTEC is electrically couplable to the prime mover.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a block diagram in partial schematic form of an illustrative alkali metal thermal-to-electricity converter (AMTEC).

FIG. 2A is schematic illustration of an illustrative combined heat and power module.

FIG. 2B is a perspective view of an illustrative combined heat and power module.

FIG. 2C is a perspective view of another illustrative combined heat and power module.

FIG. 3A is schematic illustration of another illustrative combined heat and power module.

FIGS. 3B, 3C, and 3D illustrate details regarding thermal coupling of a low pressure zone and heat exchangers.

FIG. 3E is a side plan view in partial schematic form of another illustrative combined heat and power module.

FIG. 3F is a side plan view in partial schematic form of another illustrative combined heat and power module.

FIG. 4A is a block diagram of an illustrative combined heat and power device.

FIG. 4B is a cutaway side plan view of an illustrative combined heat and power device embodied as a furnace.

FIG. 4C is a cutaway side plan view of an illustrative combined heat and power device embodied as a boiler.

FIG. 4D is a cutaway side plan view of an illustrative combined heat and power device embodied as a condensing boiler.

FIG. 4E is a cutaway perspective view of an illustrative combined heat and power device embodied as a water heater.

FIG. 4F is a block diagram of details of the combined heat and power device of FIG. 4A.

FIG. 5 is a block diagram of an illustrative combined heat and power device embodied as a backup generator.

FIG. 6 is a block diagram of an illustrative combined heat and power device embodied as a self-powering appliance.

FIG. 7 is a cross section of a discrete electrode structure for an AMTEC heat engine.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

By way of overview, various disclosed embodiments include combined heating and power modules and combined heat and power devices. As will be explained in detail below, in various embodiments illustrative combined heating and power modules include, among other things, at least one alkali metal thermal-to-electricity converter (AMTEC) and are suited to be disposed in a heating appliance such as, for example, a furnace, a boiler, or a water heater. As will also be explained in detail below, in various embodiments illustrative combined heating and power devices include, among other things, at least one alkali metal thermal-to-electricity converter (AMTEC) and are suited for use as a heating appliance such as, for example, a furnace, a boiler, or a water heater. Thus, it will be appreciated that various embodiments can help contribute to seeking to increase the electricity:heat ratio in a combined heat and power (“CHP”) or co-generation device.

Now that a non-limiting overview has been given, details will be explained by way of non-limiting examples given by way of illustration only and not of limitation.

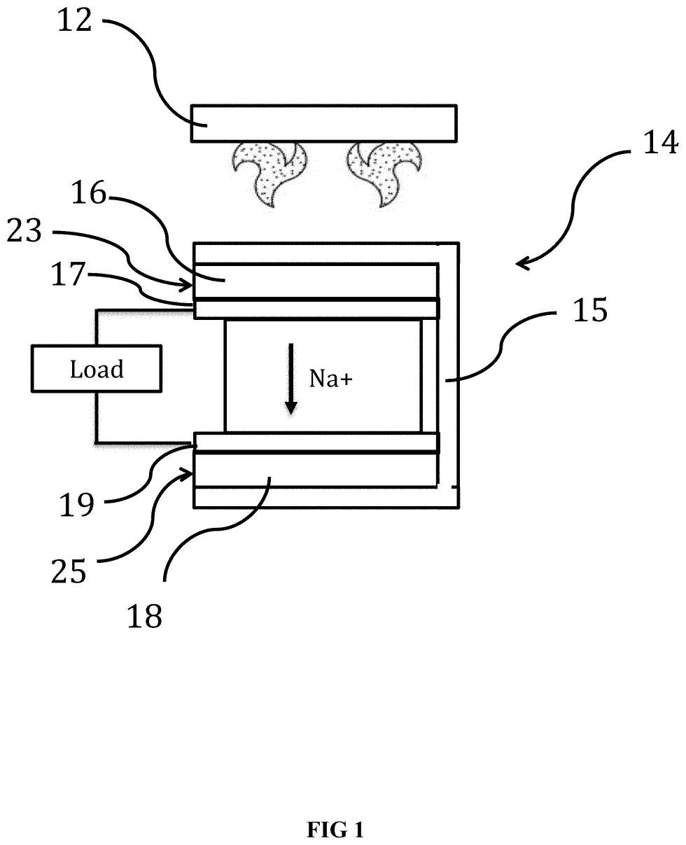

Referring to FIG. 1, in various embodiments an illustrative alkali metal thermal-to-electricity converter (AMTEC) 14 includes a working fluid 15 (such as, for example, sodium or potassium, or a mixture thereof). The working fluid 15 may be in either a liquid or gaseous state depending on the location within the AMTEC 14. The AMTEC 14 includes a high pressure side (or zone) 16, where the working fluid 15 is vaporized using input heat from a heat source (such as a burner) 12 at a temperature in a range of around 800-1300K and makes contact with an anode 17. The AMTEC 14 includes a low pressure side (or zone) 18, where the working fluid 15 is recondensed on the “cold side” (which receives heat flux from condensation) at a temperature in a range of around 400-700K and makes contact with a cathode 19. A hermetic solid electrolyte membrane 21 is an electronic insulator and an ionic conductor for ions generated from working fluid 15. The membrane 21 is functionalized (that is, made functional) with porous electronically conducting electrodes (such as the anode 17 and the cathode 19) on either side for oxidation and reduction of the working fluid 15 and for allowing extraction of electrical current. In various embodiments the electrolyte itself may be nearly universally [Na/K] β″-alumina (BASE). In various embodiments a return path for the working fluid 15 can be passive (fluid flow driven by wicking or capillary action in a porous metal or ceramic material) or active (the working fluid is pumped via electromagnetic force by an electromagnetic pump) as desired for a particular application.

As shown in FIG. 1, the high pressure zone 16 is contained within a structure 23 and the low pressure zone 18 is contained within a structure 25. In various embodiments, the structures 23 and 25 may be made from any suitable material as desired for a particular application. For example and given by way of illustration only and not of limitation, in various embodiments the structures 23 and 25 may be made from materials such as, without limitation, steel, stainless steel, a superalloy, a nichrome, a Fe—Al alloy, zircalloy, a Ti alloy (like Ti—Al), silicon carbide, an iron-chromium-aluminum alloy, a MAX-phase alloy, alumina, and zirconium diboride. In various embodiments, if desired outer surfaces of the structure 23 may be coated with at least one material configured to increase thermal emissivity, such as without limitation silicon carbide, carbon, an inorganic ceramic, a silicon ceramic, a ceramic metal composite, a carbon glass composite, a carbon ceramic composite, zirconium diboride, and/or aluminum oxide with addition of magnesium oxide. In various embodiments, if desired outer surfaces of the structure 25 may include one or more thermal transfer enhancement features, such as without limitation divots defined therein, a plurality of formed shapes formed therein, and/or a thermal grease disposed thereon.

In various embodiments, the AMTEC 14 may be any one of various suitable AMTEC cell types as desired for a particular application. The various AMTEC cell types may be differentiated by the pressure in/on the anode 17, the mechanisms of heat transfer to the solid electrolyte, and the cell design in terms of shorting between the anode 17 and cell. These AMTEC cell types are sometimes described as: (i) a liquid anode (where a reservoir of molten sodium or potassium is maintained in the anode zone in contact with the electrolyte); (ii) a vapor-vapor (where no condensation of molten working fluid occurs on the BASE, thereby allowing for flexibility in cell design (because there is not a continuous sodium electrical short between the anode 17 and housing); and (iii) a “self-internal heat pipe,” in which a wick structure induces condensation of the working fluid 15 on the anode 17, which helps heat the BASE (rather than relying on package heat conduction), thereby allowing localized presence of molten sodium without shorting.

The fundamental mechanism of power generation in the AMTEC 14 is through oxidation and reduction of the working fluid 15 (denoted as “Met” in the reactions below) at different potentials on either side of the solid electrolyte membrane. The reactions are:

Met⁰→Met⁺+e⁻(anode)

Met⁺+e⁻Met⁰(cathode)

These reactions take place at the triple phase boundary between the working fluid 15, the electrode matrix, and the solid electrolyte. As a result, performance of the system depends on the morphology of this interface, such as aspects of outward appearance, shape, structure, color, pattern, size, surface texture, roughness, features, and the like. The open circuit voltage is set by the Nernst equation:

$${V}_{o c} = \frac{R {T}_{B}}{F} ln ( \frac{{P}_{a}}{{P}_{c}} )$$

where T_{B} is the solid electrolyte temperature and Pₐ and P_{c} are the saturation vapor pressures of the working fluid 15 at the evaporator and condenser temperatures, respectively. Pₐ/P_{c} can easily reach 10⁵ in typical AMTEC cells, and so the open circuit voltage is on the order of 1V. In order to extract power, current is driven through the cell. The I-V characteristics charge transfer reaction are described by Butler-Volmer kinetics, which is characteristic of electrochemical systems with an activation energy and finite reaction site density. Expressed in terms of the overpotential (the voltage drop required to drive a current density J):

$${ξ}_{i} = \frac{R {T}_{B}}{F} ln \{ \frac{1}{2} \frac{J}{{J}_{e x , i}} {\frac{{P}_{i}}{{P}_{i 0}} [ {( \frac{J}{{J}_{e x , i}} )}^{2} + 4 \frac{{P}_{i}}{{P}_{i 0}} ]}^{1 / 2} + \frac{1}{2} \frac{{P}_{i}}{{P}_{i 0}} {( \frac{J}{{J}_{e x , i}} )}^{2} + 1 \}$$

where Pᵢ/Pᵢ₀ is the ratio of the local pressure during operation to the initial open circuit pressure, and Jₑₓ is the exchange current density. The above equation applies individually to the anode and cathode interfaces, which each have their own Jₑₓ. To complete the loop, including the additional polarization ξᵢₒₙ due to the finite ionic conductivity of the electrolyte, the output voltage under load becomes

V(Jᵢ)=V_{oc}−(ξₐ+ξ_{c})−ξᵢₒₙ

The exchange current captures the local rate constant of the reduction and oxidation reactions (in practice, also the total triple phase boundary length). Jₑₓ is also an increasing function of the electrolyte/electrode interface temperature. The above equations drive designs with T_{B} increased as much as possible without inducing degradation or seal failure.

The overall efficiency of an AMTEC cell can then be written as follows, capturing the heat input required to complete the sodium vapor cycle as well as parasitic heat losses:

$$η = {JV [ JV + \frac{jM}{F} ( h ( {T}_{{C}_{p}} ) + {\int }_{{T}_{c}}^{{T}_{H}} {c}_{p} ( T ) d T ) + {Q}_{loss} ]}^{- 1}$$

where M is the sodium molar mass, h is the latent heat of evaporation, cₚ is the heat capacity of the working fluid 15, and Qₗₒₛₛ is the total heat flux lost to parasitics (lead losses, package losses, internal radiation between the cathode 19 and condenser, heat flux through the working fluid 15 return path, and loss to the converter environment).

It will be appreciated that the anode 17 and cathode 19 are at the same temperature. As a result, there is no heat loss penalty for electrical series connections.

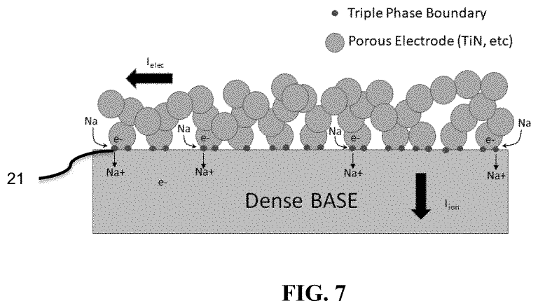

Referring additionally to FIG. 7, an important parameter in the performance of an AMTEC cell is the exchange current density Jₑₓ. This is set by the total triple phase boundary length on an AMTEC electrode, along with the intrinsic materials properties governing the reduction/oxidation reactions (such as work functions, reaction site density, surface diffusivity of sodium, and the like). As shown in FIG. 7, the electrode/electrolyte structure can be represented as a sharp interface between the ionically conductive and electrically conductive phases. With this morphology, the Na+ enters the BASE and contributes to cell current via one of three mechanisms: (i) oxidation right at the triple phase boundary 21 between sodium vapor/electrode/electrolyte; (ii) sodium is ionized on the electrode surface and diffuses as an ion on the electrode to the triple phase boundary 21; or (iii) sodium is ionized and evaporates as an ion from the electrode where it impinges on the BASE. Of these, mechanisms (i) and (ii) may be dominant, and the overall “active reaction area” may be small and localized to the interface.

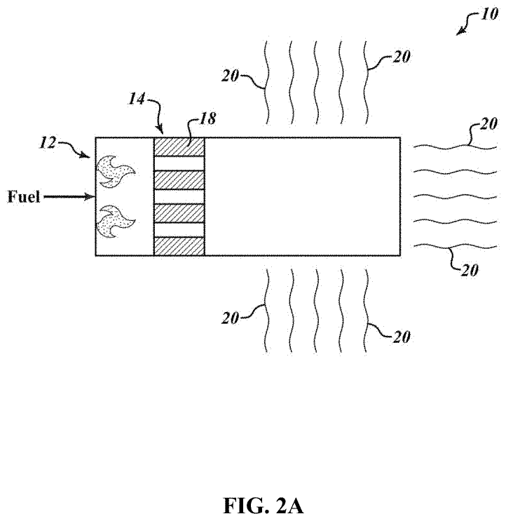

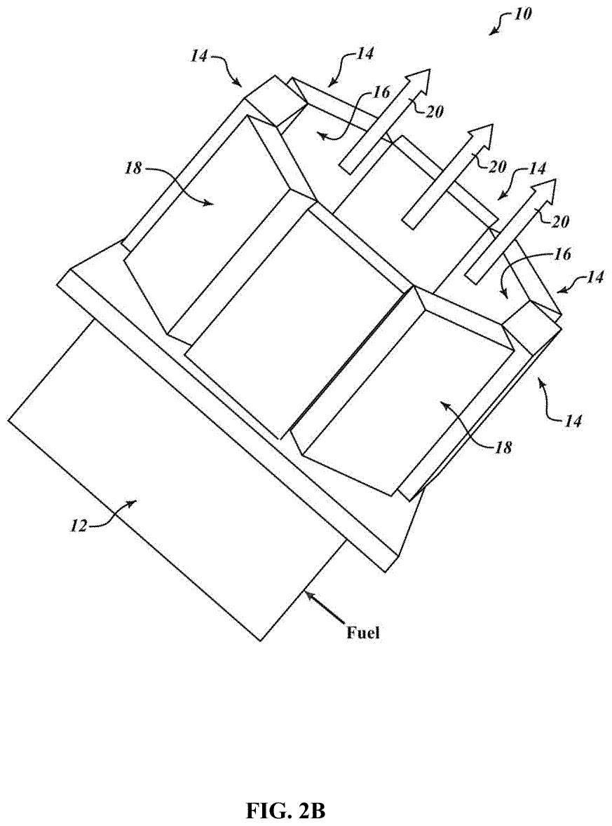

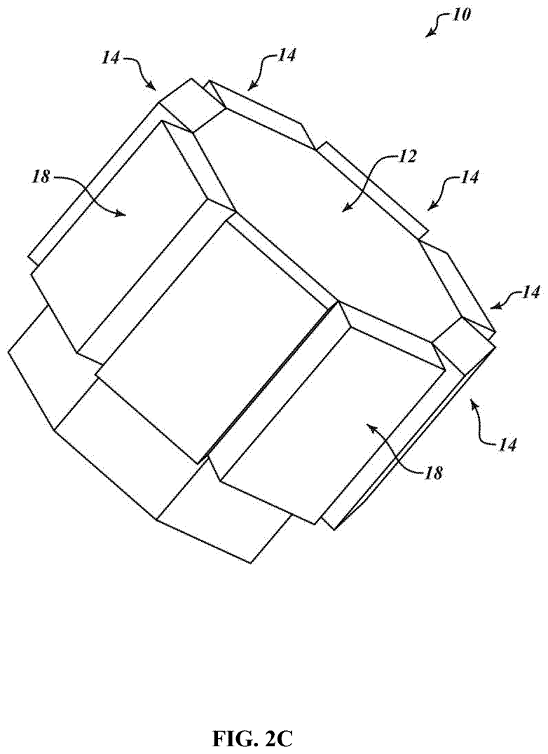

Referring to FIGS. 2A-2C, in various embodiments an illustrative combined heat and power module 10 includes at least one burner 12. At least one alkali metal thermal-to-electricity converter (AMTEC) 14 is attached to the burner 12. The AMTEC 14 has a high pressure zone 16 (FIG. 2B) and a low pressure zone 18. The high pressure zone 16 is configured to be thermally couplable to the burner 12 and the low pressure zone 18 is configured to be thermally couplable to a heat exchanger (not shown).

It will be appreciated that, because the low pressure zone 18 is configured to be thermally couplable to a heat exchanger, the module 10 is suited for use in a heating appliance such as, without limitation, a furnace, a boiler, or a water heater in settings such as a residence or a commercial building, and can help contribute to increasing overall system efficiency by helping to use waste heat from the low pressure zone 18 that may be thermally couplable to a heat exchanger in a heating appliance.

Thus, it will be appreciated that the module 10 can replace an existing boiler or gas furnace burner and can thereby allow an existing boiler/gas-furnace to be retrofitted to a combined heat and power device. The functional zones of the AMTEC 14 (that is, the zones that emit ionic charge carriers and collect the ionic charge carriers) can be formed to maximize power production and minimize the overall volume of the AMTEC 14. In addition, the burner 12 can be designed to work at the same gas and air pressure as the existing burner, thereby allowing the inlet fuel pressure and air delivery system of existing boiler/gas furnaces to be used. By creating an exhaust stream that is similar to that of the existing burner (such as, for example, flow, temperature, exhaust manifold size and connections), no further changes need be made to an existing boiler/gas furnace.

It will be appreciated that operating temperature of the high pressure zone 16 is high. Because of its high temperature, the high pressure zone 16 can lose a significant amount of energy to an appliance's environment (typically walls of a heat exchanger) through radiation. This loss can be a challenge especially for the walls of the heat exchanger that do not face the flame.

To help contribute to reducing heat loss from the side of the high pressure zone 16, in some embodiments the high pressure zone 16 is surrounded with other AMTEC cells 14. Because the temperature of these AMTEC cells 14 is also high, the amount of radiation loss is reduced.

As shown in FIG. 2B, in various embodiments the burner 12 may include a nozzle burner for use with oil as fuel or a venturi burner for use with natural gas or propane as fuel. In such embodiments, flame from the burner 12 is indicated by arrows 20.

As shown in FIG. 2C, in some embodiments the burner 12 may include a porous burner.

It will be appreciated that any numbers of burners 12 may be used in the module 10 as desired for a particular application. For example, in some embodiments the module 10 may include no more than one burner 12. However, in some other embodiments the module 10 may include more than one burner 12.

In various embodiments the burner 12 may be configured to combust with preheated air/fuel (that is, recuperation of enthalpy of exhaust gas of the burner 12 by preheating air/fuel) or using an enrichment agent such as oxygen-enriched air or hydrogen-enriched combustion. In some such embodiments, flame temperatures—and thus potentially cathode and anode temperatures—can be increased by firing with preheated air/fuel or oxygen-enriched air to aid with the hot-side heat transfer. Given by way of non-limiting example, firing with oxygen-enriched air can be accomplished by use of an oxygen concentrator/enrichment system and using this oxygen in the input stream of the burner 12. It will be appreciated that pure oxygen need not be used. For example, with use of pressure-swing-absorption-processed air (“PSA”), as little as two-fold boosting of oxygen concentration may be adequate to accomplish firing with oxygen-enriched air. Given by way of another non-limiting example, a “rapid PSA” device (that operates more isentropically) may be used as desired for a particular application. It may also be desirable to exhaust such relatively high-temperature gases quasi-adiabatically—and/or over a suitably-catalytic surface—in order to suppress NOx emissions. It will be appreciated that use of oxygen in the flame in some operating conditions can also have the effect of lowering NOx emissions despite the increased flame temperature (due to proportionally lower availability of N2 from air).

In some other such embodiments, hydrogen-enriched combustion may also result in higher flame temperatures which will help with hot-side heat transfer. In such embodiments, hydrogen-enriched combustion can be accomplished by including a device upstream on the fuel line that cracks incoming fuel (such as natural gas or methane) into hydrogen, thereby leaving behind carbon. This hydrogen is fed into the flame to raise flame temperature, thereby enhancing heat transfer from the flame to the AMTEC 14. The hydrogen may be readily sourced by thermal decomposition of the inputted natural gas (or methane) stream. It will be noted that methane is thermo-fragile and reasonably-readily decomposes into elemental carbon and molecular hydrogen. Given by way of non-limiting example, a suitable arrangement can include a microfinned heat exchange through which the methane is flowed toward the eventual combustion-region, with its hot side heated by exhausted combustion gas. Natural gas thereby refined from (most all of) its carbon content is then burned as a stream of relatively-pure hydrogen, with the carbon remaining behind in the cracking unit. It will be appreciated that, as in the oxygen-enriched air case, pure hydrogen need not be used. In some embodiments, this cracking unit may be regenerated periodically—that is, its accumulated carbon-load removed—by valving heated air (and perhaps a small amount of natural gas for ignition purposes) through it, thereby recovering the latent heat of the carbon for use downstream (for example, the primary space-or-water-heating purposes)—with a twin cracking unit being exercised in its place during this alternating split-cycle operation. Thus, in such embodiments higher temperature flame can be produced than a classic near-stoichiometric hydrogen-oxygen.

In some other embodiments, instead of fully decomposing natural gas or methane and removing carbon content for pure hydrogen combustion, preheating and decomposing the fuel (such as natural gas, methane, or propane) without carbon removal can lead to an enhancement in flame emittance which can help enhance hot-side/flame heat transfer by radiation to the AMTEC 14 and can help limit localized flame hot-spots and, therefore, NOx emissions.

In some embodiments the burner 12 may be configured for substantially stoichiometric combustion. In some such embodiments it may be advantageous to burn additional fuel (and, in some cases, possibly air) close to the high pressure zone 16 and closer to the stoichiometric mixture for enhanced heat transfer (that is, a higher flame temp). Because in some instances the AMTEC 14 may only be using a small amount (such as around five percent or so) of the total thermal power of a heating appliance such as a furnace or boiler, it is possible that the NOx increase is not significant enough to impact the rating of the systems. In some instances, only the portion of the burner 12 that provides the majority of the thermal power for heating the water (in a boiler or water tank) or the air (in a furnace) could run slightly leaner to reduce NOx to accommodate for the localized increase in NOx at or near the surface of the high pressure zone 16.

In various embodiments, the AMTEC 14 has an electrical power output capacity of no more than 50 kWe. In some such embodiments, the AMTEC 14 has an electrical power output capacity of no more than 5 kWe. In either case, it will be appreciated that the AMTEC 14 (and, as a result, the module 10) is suited for use in a heating appliance such as, without limitation, a furnace, a boiler, or a water heater in settings such as a residence or a commercial building.

In various embodiments the outer surface of the high pressure zone 16 may be coated with a material that is configured to increase thermal emissivity, thereby increasing heat transfer to the AMTEC 14. In such embodiments, the material may include any suitable material such as silicon carbide, carbon, an inorganic ceramic, a silicon ceramic, a ceramic metal composite, a carbon glass composite, a carbon ceramic composite, zirconium diboride, “black” alumina (that is, aluminum oxide with addition of magnesium oxide), or a combination thereof. It will be appreciated that the material may be tuned or roughened to increase radiative heat transfer from the burner 12 to the high pressure zone 16.

It will be appreciated that various AMTEC cells 14 can operate at lower hot side temperatures and lower cold side temperatures, thereby allowing use of more affordable ceramic components and also allowing for integration into water-based heat exchangers (because the heat rejection temperature is closer to the boiling point of water). This allows for a portion of the AMTEC 14, specifically the “cold side” or condensing side, to potentially be immersed in water for more efficient water heating.

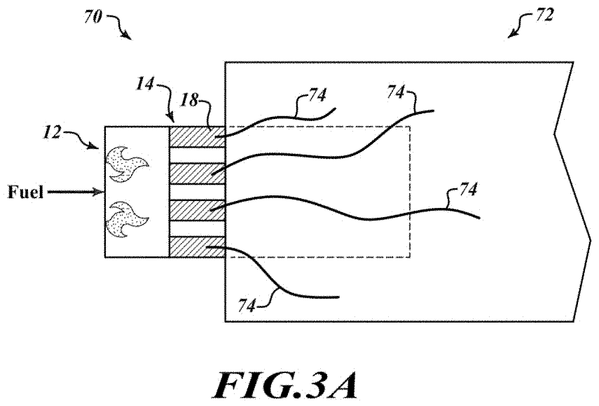

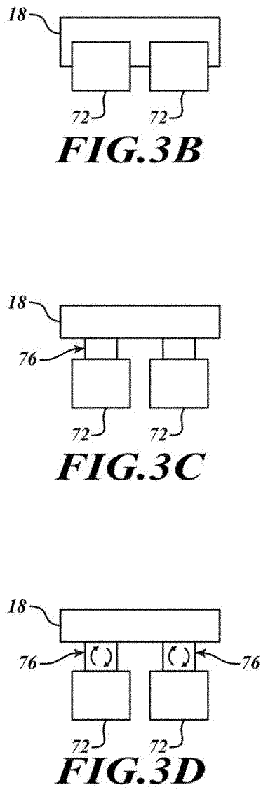

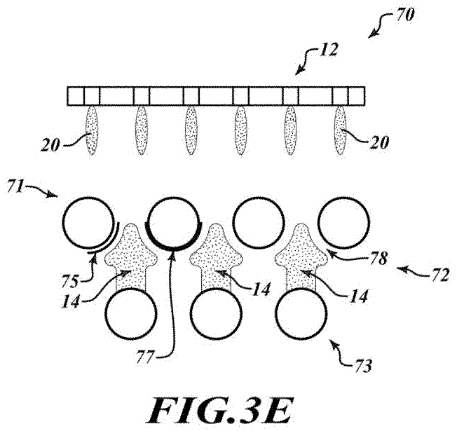

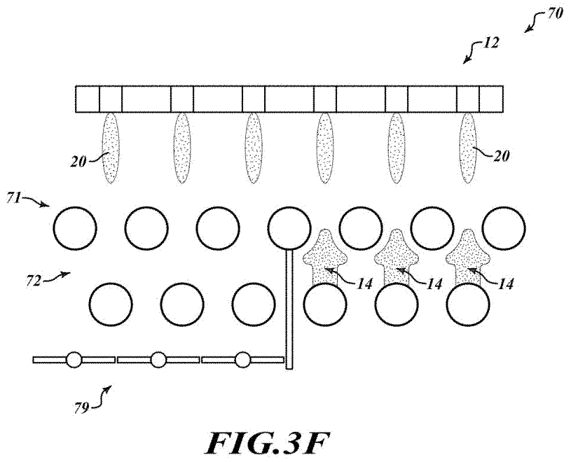

Referring additionally to FIG. 3A, in another illustrative embodiment a combined heat and power module 70 includes the burner 12. The AMTEC 14 has the high pressure zone 16 and the low pressure zone 18, and the high pressure zone 16 is configured to be thermally couplable to the burner 12. A heat exchanger 72 is configured to be thermally couplable to the low pressure zone 18. Each one of the burner 12 and the AMTEC 14 and the heat exchanger 72 is attached to at least one other of the burner 12 and the AMTEC 14 and the heat exchanger 72.

The burner 12 and the AMTEC 14 have been discussed in detail above and details of their construction and operation need not be repeated for an understanding by one of skill in the art. It will also be appreciated that heat exchangers are well known in the art and details of their construction and operation need not be discussed for an understanding by one of skill in the art.

It will be appreciated that, because the low pressure zone 18 is configured to be thermally couplable to the heat exchanger 72, the module 70 is suited for use in a heating appliance such as, without limitation, a furnace, a boiler, or a water heater in settings such as a residence or a commercial building, and can help contribute to increasing overall system efficiency by helping to use waste heat from the low pressure zone 18 (as indicated by arrows 74) that is thermally couplable to the heat exchanger 72 in a heating appliance.

In some embodiments the low pressure zone 18 and the heat exchanger 72 may be arranged such that the low pressure zone 18 and the heat exchanger 72 physically contact each other. Referring additionally to FIG. 3B, in some such embodiments the heat exchanger 72 may be closely geometrically coupled to the low pressure zone 18. In such embodiments, heat may be transferred from the low pressure zone 18 to the heat exchanger 72 via conduction, convection, and/or radiation.

However, it will be appreciated that the low pressure zone 18 and the heat exchanger 72 need not physically contact each other. To that end, in some other embodiments the low pressure zone 18 and the heat exchanger 72 are spaced apart from each other. That is, the low pressure zone 18 and the heat exchanger 72 may be arranged such that the low pressure zone 18 and the heat exchanger 72 do not physically contact each other. In such embodiments, heat may be transferred from the low pressure zone 18 to the heat exchanger 72 via convection and/or radiation.

Referring additionally to FIGS. 3C and 3D, in some such embodiments, a thermal coupler 76 may be disposed in thermal contact with the low pressure zone 18 and the heat exchanger 72. As shown in FIG. 3C, in some embodiments the thermal coupler 76 may include thermal interface material with appropriate thermal conductivity to transfer heat at the desired amount from the low pressure zone 18 to the heat exchanger 72. In some such embodiments the thermal interface material may be electrically insulating or electrically conducting. It will be appreciated that in various embodiments the thermal interface material may also be a piece of material (such as, for example, copper or other thermally conductive metals, thermally conductive metal alloys, thermally conductive ceramic, or the like) with thermal conductivity chosen to provide a desirable temperature distribution and heat transfer.

As shown in FIG. 3D, in some other embodiments the thermal coupler 76 may include a heat pipe. It will be appreciated that in embodiments that include thermal coupler 76 heat also may be transferred from the low pressure zone 18 to the heat exchanger 72 via conduction. In such embodiments, the heat pipe could be filled with a fluid, a mixture of fluids (such as water and glycol, or organic fluids like methanol or ethanol or naphthalene) or a metal (cesium, potassium, sodium, mercury, or a mixture of these). The heat pipe may be a grooved, mesh, wire, screen, or sintered heat pipe as desired for a particular application.

Referring additionally to FIG. 3E, in some embodiments the heat exchanger 72 may include a tube bank 71 and a tube bank 73. In such embodiments the AMTEC 14 may be disposed intermediate the tube bank 71 and the tube bank 73. It will be appreciated that this arrangement helps enable potential integration of the AMTEC 14 within tube banks of the heat exchanger 72 to increase flow velocity and heat transfer around the high pressure zone 16 and to reduce the view factor of the surface of the high pressure zone 16 to the burner 12. In some such embodiments the tubes of the tube bank 71 may include one or more features configured to reduce re-radiation from the AMTEC 14, such as without limitation a re-radiation shield 75 and/or thermal insulation 77 disposed on a portion of a surface of the tubes of the tube bank 71 that is proximate the AMTEC 14. In some such embodiments the AMTEC 14 may include one or more features configured to increase heat transfer to the AMTEC 14, such as without limitation fins and/or a surface texture. In some other such embodiments width of a gap 78 between tubes of the tube bank 71 and the AMTEC 14 may be optimized for flow conditions.

Referring additionally to FIG. 3F, in some embodiments a structure 102 may be configured to restrict exhaust from the burner 12 to portions of the heat exchanger 72 that are thermally couplable with the AMTEC 14. It will be appreciated that it may not be desirable to use a thermal power turn-down ratio that is too large to avoid losing emitter temperature. However, in applications with larger turn-down ratios the structure 102 can block exhaust flow and guide the flow through bank(s) with the AMTEC cells 14 or can restrict the exhaust gas flow through parts of the heat exchanger 72 without the AMTEC cells 14.

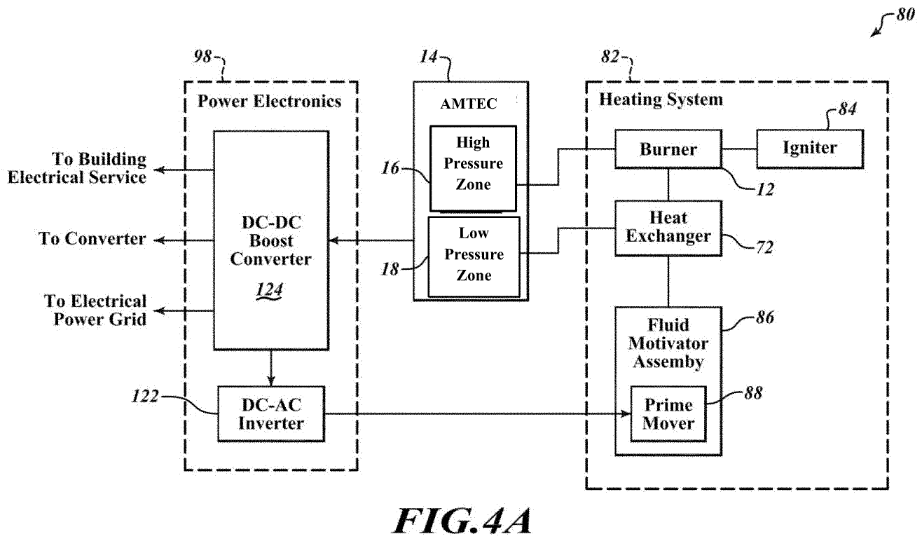

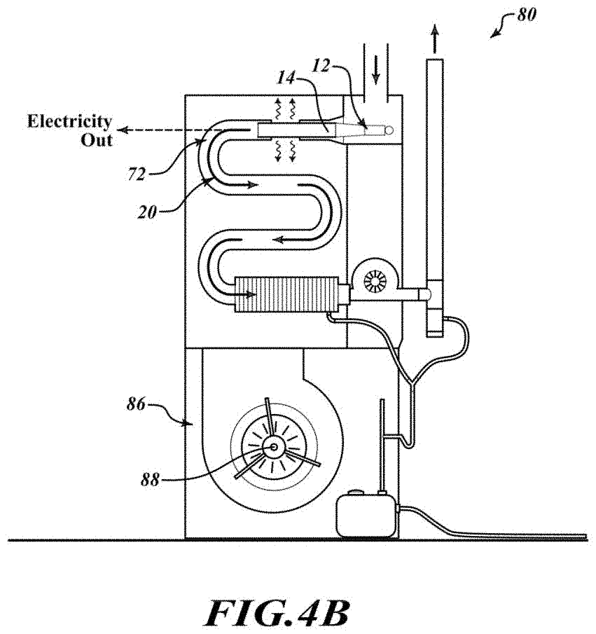

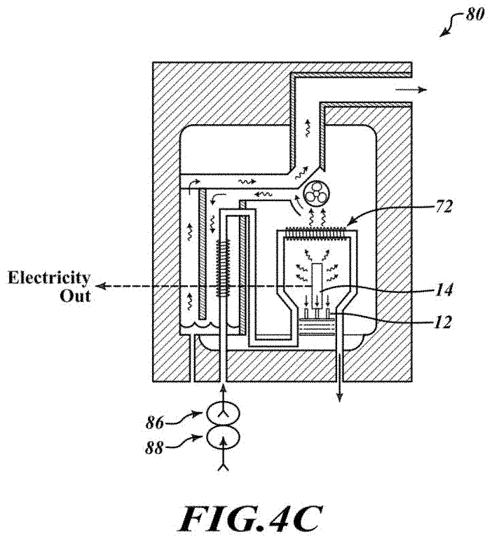

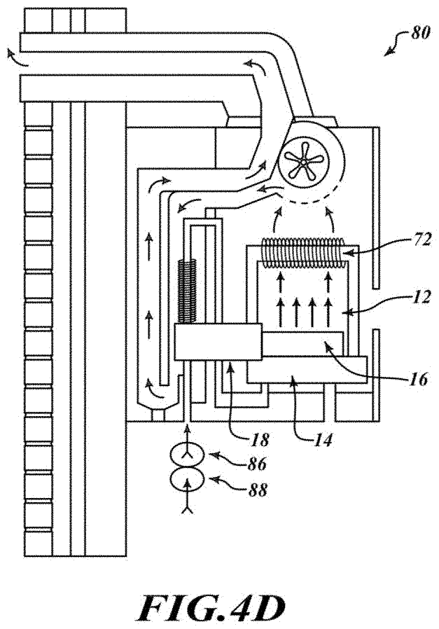

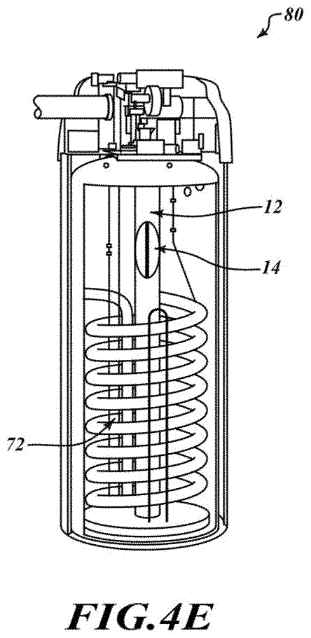

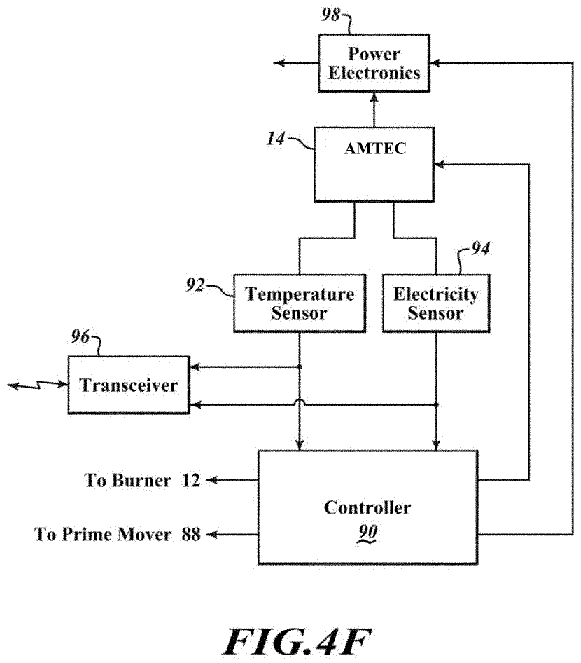

Referring additionally to FIG. 4A, in various embodiments a combined heat and power device 80 is provided. The combined heat and power device 80 includes a heating system 82. The heating system 82 includes at least one burner 12, at least one igniter 84 configured to ignite the at least one burner 12, a fluid motivator assembly 86 including an electrically powered prime mover 88, and the heat exchanger 72 fluidly couplable to the fluid motivator assembly 86. At least one AMTEC 14 has a high pressure zone 16 and a low pressure zone 18. The high pressure zone 16 is thermally couplable to the burner 12 and the low pressure zone 18 is thermally couplable to the heat exchanger 72.

The burner 12 and the AMTEC 14 have been discussed in detail above and details of their construction and operation need not be repeated for an understanding by one of skill in the art. It will also be appreciated that heat exchangers are well known in the art and details of their construction and operation need not be discussed for an understanding by one of skill in the art. Also, thermal coupling between burner 12 and the AMTEC 14 and between the AMTEC 14 and the heat exchanger 72 have been discussed in detail above and their details need not be repeated for an understanding by one of skill in the art.

In some embodiments the burner 12 and the AMTEC 14 may be installed in the combined heat and power device 80 as the module 10. However, in some other embodiments the burner 12 and the AMTEC 14 may be installed individually in the combined heat and power device 80. Similarly, in some embodiments heat exchanger 72 may be installed in the combined heat and power device 80 as part of the module 70. However, in some other embodiments the heat exchanger 72 may be installed individually in the combined heat and power device 80.

Referring additionally to FIGS. 4B-4E, in various embodiments the combined heat and power device 80 may include without limitation a heating appliance such as, for example, a furnace (FIG. 4B), a boiler (FIGS. 4C and 4D), or a water heater (FIG. 4E).

In embodiments in which the combined heat and power device 80 includes a furnace (FIG. 4B), the fluid motivator assembly 86 includes an air blower and the prime mover 88 includes a blower motor. Given by way of non-limiting example, the furnace may be a residential or commercial furnace that is used to heat and distribute air for heating a residence or other building. Furnaces are well known in the art and further details regarding their construction and operation are not necessary for an understanding of disclosed subject matter.

In embodiments in which the combined heat and power device 80 includes a boiler (FIGS. 4C and 4D) or a water heater (FIG. 4E), the fluid motivator assembly 86 includes a water circulator pump and the prime mover 88 includes a pump motor. Given by way of non-limiting example, the boiler may be a residential or commercial boiler that is used to heat water and distribute hot water and/or steam in a residence or other building. Given by way of non-limiting example, the water heater may be a residential or commercial water heater that is used to heat water and store hot water for use in a residence or other building. Boilers and water heaters are well known in the art and further details regarding their construction and operation are not necessary for an understanding of disclosed subject matter.

In embodiments in which the combined heat and power device 80 includes a boiler (FIGS. 4C and 4D) the boiler may be a conventional boiler (FIG. 4C) or a condensing boiler (FIG. 4D). In embodiments in which the combined heat and power device 80 includes a condensing boiler (FIG. 4D), the heat exchanger 72 also acts as a condenser that cools exhaust fumes which are saturated with steam and which condense into water in the liquid state, using the water from the heating system at low temperature (approximately 50° C.) circulating through it. The heat which the exhaust fumes transfer to the heat exchanger 72 in turn heats the water in the heating system.

Referring additionally to FIG. 4F, in various embodiments a controller 90 is configured to control the burner 12, the AMTEC 14, and the prime mover 88. It will be appreciated that the controller 90 may be any suitable computer-processor-based controller known in the art. Illustrative functions of the controller 90 will be explained below by way of illustration and not of limitation.

In various embodiments a temperature sensor 92 is configured to sense temperature of the AMTEC 14 and at least one electricity sensor 94 is configured to sense electrical output (that is, voltage and/or current) of the AMTEC 14. Output signals from the temperature sensor 92 and the electricity sensor 94 are provided to the controller 90. In some embodiments output signals from the temperature sensor 92 and the electricity sensor 94 may be provided to a transceiver 96 that is configured to transmit and receive data regarding the temperature sensor 92 and the electricity sensor 94.

It will be appreciated that the combined heat and power device 80 enabled with the temperature sensor 92 and the electricity sensor 94 can collect data on heat and electricity output. It will also be appreciated that the controller 90 is configured to process the data for optimization. That is, the combined heat and power device 80 can draw inferences on the time-and-magnitude of usage patterns and can help toward optimizing its future behavior (for example, to pre-heat the building at predicted times—such as before an occupant or employee usually returns).

It will also be appreciated that the combined heat and power device 80 enabled with the temperature sensor 92 and the electricity sensor 94 can transmit data wirelessly to-and-from other electricity-consuming devices in the building (such as, for example, an electric car, air conditioner and HVAC, smart home hubs, smart home assistants, and the like) so that these devices can modulate their own or other device's utilization of electricity and so that the electricity and heat demand of the building more closely matches the supply of electricity and heat from the combined heat and power device 80.

It will also be appreciated that the combined heat and power device 80 enabled with the temperature sensor 92 and the electricity sensor 94 can transmit data wirelessly to-and-from the electric utility and/or regulator. As a result, electricity generation can be scheduled in advance or can be dispatched on command such that the produced electricity is fed in reverse through an electrical meter back onto the grid.

Finally, it will also be appreciated that output from an AMTEC cell is a function of temperature of the high and low pressure zones. Over time, the performance of a boiler and gas furnace is reduced because of changes in the combustion system and heating surface—for instance because of fouling of components. Multiple components may be susceptible to these degradations. In the combustion system, for example, degradation of the blower can reduce combustion air flow. This reduction in combustion air flow may increase the flame temperature and, as a result, the power output from the AMTEC cell. In the heat exchanger, fouling of the heating surfaces lowers the temperature of the heating fluid because the total heat transfer is lowered. Additionally, the heat up rate of the building or hot water supply is impacted by changes to these system components. After prolonged use of the combined heat and power device 80, the time it will take the combined heat and power device 80 to heat the heating fluid will change. Because the AMTEC 14 is connected to both the heating and cooling portion of the combined heat and power device 80, the degradation of the heating demand response can be determined without the use of any thermocouples. As is known, thermocouples only measure a local temperature—whereas the alkali metal thermal-to-electricity converters (AMTECs) provide a more global visibility of the impact on temperature variations. In some systems, then, the temperature monitoring of the system can be enhanced with monitoring the performance of the AMTEC 14 instead of or in addition to the use of thermocouples or other sensors.

In various embodiments the controller 90 is further configured to modulate electricity output from the AMTEC 14. In some such embodiments the controller 90 modulates electricity output from the AMTEC 14 based upon an attribute such as a number of burners 12 and/or a number of alkali metal thermal-to-electricity converters (AMTECs) 14. For example, in some embodiments the combined heat and power device 80 may include multiple burners 12 and multiple alkali metal thermal-to-electricity converter (AMTECs) 12, and one or more of the burners 12 may not be thermally coupled to any of the alkali metal thermal-to-electricity converter (AMTEC)s 12. In some such embodiments the controller 90 is further configured to turn on burners 12 that are thermally couplable to alkali metal thermal-to-electricity converter (AMTEC)s 14 before turning on burners 12 that are not thermally couplable to alkali metal thermal-to-electricity converter (AMTECs) 14. Likewise, in some embodiments the controller 90 is further configured to turn off burners 12 that are not thermally couplable to alkali metal thermal-to-electricity converters (AMTECs) 14 before turning off burners 12 that are thermally couplable to alkali metal thermal-to-electricity converter (AMTECs) 14. It will be appreciated that such a scheme increases utilization time and can help spread out the occurrence of wear and tear on each individual AMTEC 14, thereby helping contribute to prolonging overall system lifetime.

In various embodiments the controller 90 is configured to modulate electrical power output of the AMTEC 14 at a power point that differs from a maximum power/efficiency point on a current-voltage profile of the AMTEC 14.

In some embodiments the controller 90 may be further configured to modulate the burner 12 (also known as “turndown”) when little heat is desired. In such embodiments, the burner 12 can modulate/turndown up to N:1 (that is, operate at 1/N its rated capacity). In some embodiments, the burner 12 may include multiple sub-burners. One or more of these sub-burners can be thermally couplable to an AMTEC 14. The burner 12 with the AMTEC 14 could operate at 1/N of its rated capacity and keep the AMTEC 14 hot, thereby generating electricity the entire time, thereby resulting in a higher utilization rate. In such embodiments the controller 90 may be further configured to turn all burners 12 at maximum capacity to provide desired heating quickly. Then, when the desired temperature is reached and less heat is desired, the controller 90 turns off all but one burner 12 which stays on preferentially to keep the AMTEC 14 hot, thereby generating electricity the entire time and resulting in a higher utilization rate.

In some embodiments the controller 90 can be configured for multi-cell alkali metal thermal-to-electricity converter (AMTEC) modulation. For example, there may be instances in which less electricity is needed at a given time, or it is cheaper to buy electricity from the grid, or batteries are fully charged (or some other scenario where it is not desired to generate electricity with the AMTEC 14.

Thus, it will be appreciated that modulation can help contribute to matching demand in the building (as indicated by a smart home-type controller that may or may not be connected to receive information about energy use in the building or on the electricity or fuel grids). It will also be appreciated that modulation can help contribute to tuning the heat:electricity ratio and can turn up/down depending on the amount of heat desired. It will also be appreciated that modulation can help increase (with a goal of maximizing) economic return, such as by turning on only a burner 12 with an associated AMTEC 14 to sell electricity back to the larger electricity grid (if heat is not desired but the goal is to maximize money) and excess heat could be stored in a tank/storage battery of some sort (such as a hot water tank).

In various embodiments power electronics 98 are electrically coupled to the AMTEC 14. In various embodiments the power electronics 98 is configured to boost DC voltage (via a DC-DC boost converter 124) and/or invert DC electrical power to AC electrical power (via a DC-AC inverter 122). Because output voltage from the AMTEC 14 is relatively low, the power electronics 98 boost output voltage from the AMTEC 14 to useful voltages. The DC-AC inverter 122 transforms the boosted DC voltage to an AC voltage in order to export power to the building, or to run AC driven boiler/furnace components, or to transfer power to the local electrical grid outside the building.

In various embodiments inlet air to the burner 12 and/or inlet fuel to the burner 12 may be pre-heated. In some embodiments the power electronics 98 is disposed in thermal communication with inlet air to the burner 12 and/or inlet fuel to the burner 12. Loss of efficiency in the power electronics 98 can be recovered by using inlet air to the burner 12 and/or inlet fuel to the burner 12 as a cooling stream for the power electronics 98. Lost heat will then be passed into the intake stream, which preheats it and is recovered. By locating the power electronics 98 in or near the incoming stream of air and/or fuel, the heat lost in the power electronics 98 can be used to preheat the intake air, thereby recapturing some of this energy that would otherwise be lost.

In some embodiments a recuperator 100 is configured to pre-heat inlet air to the burner 12 and/or inlet fuel to the burner 12 with exhaust gas from the burner 12.

In various embodiments the combined heat and power device 80 is configured to be electrically couplable to an electrical bus transfer switch.

In various embodiments a resistive heating element is electrically connectable to the AMTEC 14. In some embodiments it may be desirable to use the excess power that is produced by the AMTEC 14 (that is, electricity produced in excess to the load demand by the building grid) and send that power to a resistive heater. It will be appreciated that the full energy production potential from the AMTEC 14 may be substantially used and that modulation is not required.

In various embodiments the combined heat and power device 80 can be operated to produce higher electricity output to meet high electricity demand. In some of these cases, more heat may be generated than is desired at a given time. In such instances, the excess heat can be handled by at least the following: (i) attach a hot water tank to take the excess heat, thereby storing the heat for space heating or hot water that can be delivered later; (ii) attach phase change material to take some of the excess heat, thereby storing the heat for space heating or hot water than can be delivered later; (iii) attach an absorption cycle cooling system to take the excess heat and generate cooling; (iv) transmitting a signal to the building air duct system, which can open-or-close an opening to allow the heated air to partially flow outside the building; and (v) direct the excess heat flow into the flue gas exhaust tube of the combined heat and power device 80 via a controllable valve.

It will also be appreciated that the combined heat and power device 80 can use external data including weather, real-time and future (day-ahead) energy market prices, utility generation forecast, demand forecast data, or externally- (cloud-) computed algorithms based on such data to help optimize use of the AMTEC 14 or to help create optimized economic value for the owner of the building or external parties (such as utilities or energy service companies).

It will also be appreciated that multiple combined heat and power devices 80 (such as in different buildings and/or across geographies) can be aggregated and controlled (either through the internet and/or wireless networks) in tandem to provide grid ancillary services that can help contribute to offering more value to utilities and grid operators than a single combined heat and power device 80 alone. For example, a utility seeing a dangerous spike in energy demand on a specific substation could switch on and control all AMTEC cells in the distribution grid for that substation, thereby reducing demand for each home and, thus, reducing the load on the substation or distribution grid. Similarly, other grid services may be provided, including capacity, voltage and frequency response, operating reserves, black start, and other compensated services.

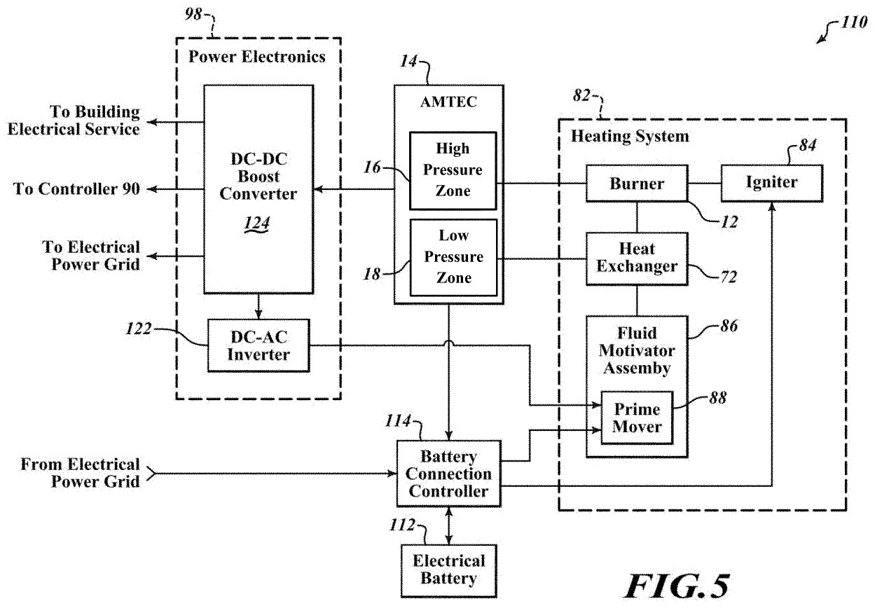

Referring additionally to FIG. 5, in various embodiments a combined heat and power device 110 may provide a backup generator. In such embodiments the combined heat and power device 110 can turn on in case of electrical grid outage to provide electrical power. It will be appreciated that the gas grid does not go out, whereas the combined heat and power device 110 may be coupled with a transfer switch to electrical systems in the building. Thus, electrical power from the AMTEC 14 can power the electricity-consuming components of the combined heat and power device 110 itself (such as controls, motors, blowers, sensors, and the like) during an electrical power outage.

In such embodiments, the combined heat and power device 110 includes a heating system 82. The heating system 82 includes at least one burner 12, at least one igniter 84 configured to ignite the at least one burner 12, a fluid motivator assembly 86 including an electrically powered prime mover 88, and the heat exchanger 72 fluidly couplable to the fluid motivator assembly 86. At least one AMTEC 14 has a high pressure zone 16 and a low pressure zone 18. The high pressure zone 16 is thermally couplable to the burner 12 and the low pressure zone 18 is thermally couplable to the heat exchanger 72. An electrical battery 112 is electrically connectable to the igniter 84 and the prime mover 88 and system controls.

From a cold start, the electrical battery 112 powers the igniter 84 and the prime mover 88 and system controls. After startup, the AMTEC 14 powers the prime mover 88 and system controls and recharges the electrical battery 112.

In some embodiments a battery connection controller 114 is configured to electrically connect the electrical battery 112 to the igniter 84 and the prime mover 88 and system controls. In some such embodiments the battery connection controller 114 may be further configured to electrically connect the electrical battery 112 to the igniter 84 and the prime mover 88 and system controls automatically in response to loss of electrical power from an electrical power grid. In some other such embodiments the battery connection controller 114 may be further configured to electrically connect the electrical battery 112 to the igniter 84 and the prime mover 88 and system controls manually by actuation by a user.

In some embodiments the battery connection controller 114 may be further configured to electrically connect the electrical battery 112 to the AMTEC 14 to charge the electrical battery 112.

In some embodiments the heat exchanger 72 may be configurable to direct fluid disposed therein to an interior environment of a building, ambient environment exterior a building, and/or a thermal storage reservoir, such as for example a water tank.

Thus, in such embodiments, as long as the gas supply is steady (which is more reliable than the electrical grid), the combined heat and power device 110 can run on electrical power from the AMTEC 14 alone. It will be appreciated that the AMTEC 14 is to be sized to power all of the electrical loads of the combined heat and power device 110. Given by way of non-limiting examples, these electrical loads can be in a range of less than 50 W, between 50 W and 200 W, or in some cases more than 200 W—depending on the size and power draws of various components.

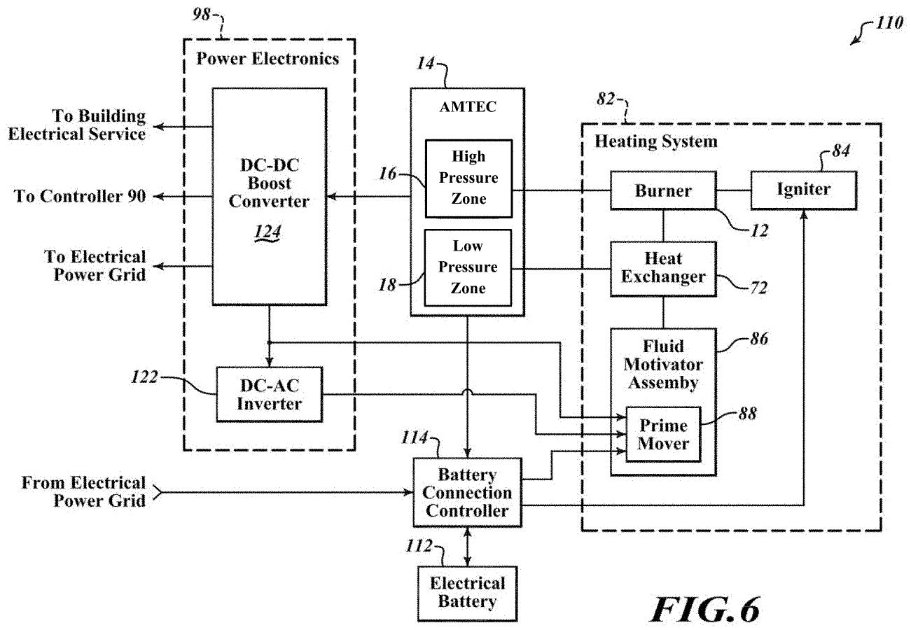

Referring additionally to FIG. 6, in various embodiments a combined heat and power device 120 may provide a self-powering appliance, such as a furnace, a boiler, or a water tank. It will be appreciated that use as self-powering boiler or furnace can help contribute to resulting in a lower utility bill and/or a furnace and/or boiler that still works when electrical grid (or other) power goes out. Generally, the AMTEC 14 can be incorporated into a boiler or furnace and the electricity generated thereby can be used to power these heating appliances, so that they can operate even if there was no external electricity delivered to the unit (for example, during an electrical grid blackout). Also, electrical power from the AMTEC 14 could be used to directly drive motors, blowers, control units, pumps, fans, and the like rather than pulling this electrical power from the electrical supply grid, thereby reducing electrical consumption from the electrical supply grid and increasing energy ratings and offsetting electrical power that previously had to be purchased from the electrical supply grid (thereby helping contribute to lowering utility bills).

The electrical components of the combined heat and power device 120 typically range from less than 100 Watts of electrical power, between 100 W and 300 W, or in some cases more than 300 W depending on the size and power requirements of various components (blowers, fans, electronic controls, and the like). By incorporating the AMTEC 14 into the combined heat and power device 120 and interfacing with the burner 12, illustrative disclosed AMTECs 14 can help provide enough power to help keep the combined heat and power device 120 running without any external grid electricity.

In this scenario, the power output from the AMTEC can be conditioned using a combination of DC-DC boost converters (for DC components like control boards) and/or inverters (for AC components like some motors) and similar power electronics. In many newer furnaces, DC motors are replacing AC motors in which case an inverter may not be required. In any case, it is important that the AMTEC needs to be sized to power all of the electrical needs of the heating appliance. This can be as in a range of less than 100 Watts of electrical power, between 100 W and 300 W or in some cases more than 300 W depending on the size and power requirements of the boiling components (blowers, fans, electronic controls, etc.)

In various embodiments, the combined heat and power device 120 includes a heating system 82. The heating system 82 includes at least one burner 12, at least one igniter 84 configured to ignite the at least one burner 12, a fluid motivator assembly 86 including an electrically powered prime mover 88, and the heat exchanger 72 fluidly couplable to the fluid motivator assembly 86. At least one AMTEC 14 has a high pressure zone 16 and a low pressure zone 18. The high pressure zone 16 is thermally couplable to the burner 12 and the low pressure zone 18 is thermally couplable to the heat exchanger 72. The AMTEC 14 is electrically couplable to the prime mover.

In some embodiments, the combined heat and power device includes a DC-AC inverter 122. In such embodiments, the prime mover 88 includes an AC motor and the prime mover 88 is electrically coupled to receive AC electrical power from the DC-AC inverter 122.

In some embodiments, the combined heat and power device includes a DC-DC boost converter. In such embodiments the controller 90 (FIG. 4F) is configured to control the burner 12, the AMTEC 14, and/or the prime mover 88. The controller 90 is electrically coupled to receive DC electrical power from the DC-DC boost converter 124. Also, in some embodiments for furnace applications, the fluid motivator assembly 86 may include a direct-current electric fan as the blower assembly and the prime mover 88 may include a direct-current blower motor (instead of the usual alternating-current ones). In such embodiments, the direct-current electricity output of the AMTEC 14 is transformed via the power electronics 98 and the DC-DC boost converter 124 to a different voltage that is used to drive the direct-current electric fans.

In various embodiments, electrical power output of the AMTEC 14 is at least 100 W.

In some embodiments the combined heat and power device includes the electrical battery 112. In such embodiments the battery connection controller 114 is configured to electrically connect the electrical battery 112 to the igniter 84 and the prime mover 88. In some such embodiments the battery connection controller 114 may be further configured to electrically connect the electrical battery 112 to the AMTEC 14 to charge the electrical battery 112.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A combined heating and power module comprising:
at least one burner; and
at least one alkali metal thermal-to-electricity converter (AMTEC) attached to the at least one burner, the at least one AMTEC having a high pressure zone and a low pressure zone, the high pressure zone being configured to be thermally couplable to the at least one burner, the low pressure zone being configured to be thermally couplable to a heat exchanger.

2. The combined heating and power module of claim 1, wherein the at least one burner includes a burner chosen from a nozzle burner and a venturi burner.

3. The combined heating and power module of claim 1, wherein the at least one burner includes a single-ended recuperative burner.

4. The combined heating and power module of claim 1, wherein the at least one burner includes a porous burner.

5. The combined heating and power module of claim 1, wherein the at least one burner includes no more than one burner.

6. The combined heating and power module of claim 1, wherein the at least one burner includes a plurality of burners.

7. The combined heating and power module of claim 1, wherein the at least one burner is configured to combust using an enrichment agent chosen from oxygen-enriched air and hydrogen-enriched combustion.

8. The combined heating and power module of claim 1, wherein the at least one burner is configured for substantially stoichiometric combustion.

9. The combined heating and power module of claim 1, wherein at least a portion of a component chosen from the high pressure zone and a component thermally coupled to the high pressure zone is located in an exhaust stream from the at least one burner.

10. The combined heating and power module of claim 1, wherein the at least one AMTEC has an electrical power output capacity of no more than 50 KWe.

11. The combined heating and power module of claim 10, wherein the at least one AMTEC has an electrical power output capacity of no more than 5 KWe.

12. The combined heating and power module of claim 1, wherein the high pressure zone is contained within a structure with outer surfaces that are coated with a material configured to increase thermal emissivity.

13. The combined heating and power module of claim 12, wherein the material includes at least one material chosen from silicon carbide, carbon, an inorganic ceramic, a silicon ceramic, a ceramic metal composite, a carbon glass composite, a carbon ceramic composite, zirconium diboride, and aluminum oxide with addition of magnesium oxide.

14. The combined heating and power module of claim 1, wherein the high pressure zone is contained within a first structure and the low pressure zone is contained within a second structure, the first structure and the second structure being made from a material chosen from steel, stainless steel, a superalloy, a nichrome, a Fe—Al alloy, zircalloy, a Ti alloy, silicon carbide, an iron-chromium-aluminum alloy, a MAX-phase alloy, alumina, and zirconium diboride.

15. The combined heating and power module of claim 1, wherein the low pressure zone is contained within a structure with outer surfaces that include at least one thermal transfer enhancement feature chosen from a plurality of divots defined therein, a plurality of formed shapes formed therein, and a thermal grease disposed thereon.

16.-73. (canceled)
